(19) United States
(12) Patent Application Publication
(10) Pub. No.: US 2026/0245912 A1
(43) Pub. Date: Aug. 20, 2026

(54) SODIUM-ION BATTERY

(71) Applicant: SHENZHEN CAPCHEM TECHNOLOGY CO., LTD., Shenzhen, Guangdong (CN)

(72) Inventors: Zhongbo Liu, Shenzhen, Guangdong (CN); Yang Liu, Shenzhen, Guangdong (CN); Xiaohu Ao, Shenzhen, Guangdong (CN); Zhongtian Zheng, Shenzhen, Guangdong (CN)

(21) Appl. No.: 19/489,589

(22) PCT Filed: May 10, 2024
(86) PCT No.: PCT/CN2024/092122

§ 371 Date: Dec. 3, 2025

(30) Foreign Application Priority Data
Jul. 18, 2023 (CN) 202310881878.X

(51) Int. Cl. H01M 4/62; H01M 10/054; H01M 10/0567

(52) U.S. Cl. CPC H01M 4/628; H01M 10/054; H01M 10/0567

(57) ABSTRACT

Provided is a sodium-ion battery, comprising a non-aqueous electrolyte, a positive electrode, and a negative electrode. The non-aqueous electrolyte includes an additive comprising a sodium salt additive. The positive electrode includes a positive electrode active substance layer containing a sodium-supplementing additive and a positive electrode active material. The sodium-supplementing additive is a sodium-rich transition metal oxide. The negative electrode includes a negative electrode active material. The sodium-ion battery satisfies the following relationship: 0.3≤a/(b+c)≤1.5, 5≤a≤10, 1≤b≤10, and 2≤c≤12. A total mass of the sodium-supplementing additive and the positive electrode active material is 100%, a represents a mass content of the sodium-supplementing additive, in %; b represents a mass content of the sodium salt additive in the non-aqueous electrolyte, in %; c represents a particle size of the negative electrode active material, in μm. The sodium-ion battery reduces the internal resistance of the battery and improves initial coulombic efficiency and cycle performance.

### TECHNICAL FIELD

The present disclosure belongs to the technical field of batteries, and in particular to a sodium-ion battery.

### BACKGROUND

The principle and structure of sodium-ion batteries are similar to those of lithium-ion batteries. Compared to lithium-ion batteries, resources for sodium-ion batteries are more abundant, at a lower cost and smaller price fluctuations, as well as a larger temperature range and higher safety performance, making them promising alternatives. With the continuous advancement of sodium-ion battery technology, sodium-ion batteries will play an essential role in China's energy system, particularly with strong growth potential in the field of energy storage. As a result, developing high-performance, low-cost sodium-ion batteries is a key factor in whether the technology can be industrialized. Hard carbon, due to its stable structure, excellent electrical conductivity, high storage capability for sodium, and large capacity, has become one of the negative electrode materials exhibiting outstanding performance and great potential for industrial application in sodium-ion batteries. However, the formation of the SEI film (Solid Electrolyte Interphase) on the hard carbon and the side reactions at the electrode interface cause more severe irreversible loss of sodium ions, as hard carbon contains numerous defects and has a relatively large specific surface area. Such irreversible loss directly reduces the energy density and shortens the cycle life of sodium-ion batteries, and the effect is particularly pronounced in sodium-ion full cells. To address the above issues, researchers have developed various sodium-supplementing techniques to compensate for the irreversible loss of sodium ions and improve the initial coulombic efficiency of sodium-ion batteries. For example, Chinese patent CN111293290A discloses a sodium-rich transition metal oxide composite sodium-supplementing positive electrode active material, the sodium-supplementing additive is sodium-rich transition metal oxide with a chemical formula of NaₓMO_{y}; wherein M is one or more selected from the group consisting of Ni, Co, Fe, Mn, Ru, Ir, Sn, Cr, Cu, Nb, and Mo. This material uses two or more sodium-supplementing materials mixed as a positive electrode additive, which can effectively compensate for the loss of active sodium in sodium-ion batteries. However, the sodium-rich transition metal oxide used as a sodium-supplementing additive exhibits poor electrical conductivity, high impedance, high reactivity, and a tendency to decompose and generate gas, resulting in batteries with low initial coulombic efficiency and poor cycle performance. Therefore, it is of great significance to develop sodium-ion batteries that include a sodium-supplementing additive capable of improving the performance of the sodium-rich transition metal oxide.

### SUMMARY

In view of the technical problem of low initial coulombic efficiency and poor cycle performance in sodium-ion batteries using a sodium-supplementing additive containing a sodium-rich transition metal oxide, the present application provides a sodium-ion battery.

The technical solution adopted by the present disclosure to solve the above technical problem is as follows:

In one aspect, the present application provides a sodium-ion battery, including a non-aqueous electrolyte, a positive electrode, and a negative electrode. The non-aqueous electrolyte includes an additive, the additive including a sodium salt additive, the positive electrode includes a positive electrode active substance layer, the positive electrode active substance layer including a sodium-supplementing additive and a positive electrode active material, the sodium-supplementing additive being a sodium-rich transition metal oxide, the negative electrode includes a negative electrode active material;
the sodium-ion battery satisfies the following relationship:

$$0.3 \leq a / ( b + c ) \leq 1.5 , and 5 \leq a \leq 10 , 1 \leq b \leq 10 , 2 \leq c \leq 12 ;$$

a total mass of the sodium-supplementing additive and the positive electrode active material is 100%, a represents a mass content of the sodium-supplementing additive, in %;
b represents a mass content of the sodium salt additive in the non-aqueous electrolyte, in %; and
c represents a particle size of the negative electrode active material, in μm.

Preferably, the sodium-ion battery satisfies the following relationship: 0.5≤a/(b+c)≤1.2.

Preferably, the total mass of the sodium-supplementing additive and the positive electrode active material is 100%, and the mass content (a) of the sodium-supplementing additive is in a range of 5.5%-9%.

Preferably, the sodium salt additive includes one or more selected from the group consisting of sodium bis(fluorosulfonyl)imide, sodium difluoro (oxalato) borate, and sodium difluorophosphate;
the mass content (b) of the sodium salt additive in the non-aqueous electrolyte is in a range of 2%-6%.

Preferably, the particle size (c) of the negative electrode active material is in a range of 3 μm-9 μm.

Preferably, the additive further includes 1,3-propane sultone, and a mass content of the 1,3-propane sultone in the non-aqueous electrolyte is 0.5%-2%.

Preferably, the mass content of the 1,3-propane sultone in the non-aqueous electrolyte is 1%-2%.

Preferably, the sodium-rich transition metal oxide includes a compound represented by Formula 1:

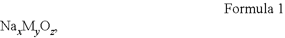

where 0.2<x/y<9, 0<y<6, 2≤z≤9, and M is selected from one or more of Nb, V, Ta, Mn, Fe, Cr, Co, Ni, Cu, Zn, Mg, Ti, Si, Sn, Ce, and Zr.

Preferably, the sodium-rich transition metal oxide includes one or more selected from the group consisting of Na₅NbO₅, Na₃NbO₄, Na₄Nb₂O₇, Na₅VO₅, Na₃VO₄, and Na₃TaO₄.

Preferably, the non-aqueous electrolyte further includes an electrolyte salt, an auxiliary additive, and a non-aqueous organic solvent;
the electrolyte salt including at least one selected from the group consisting of sodium hexafluorophosphate, sodium trifluoromethanesulfonimide, sodium trifluoromethanesulfonate, sodium tetrafluoroborate, sodium perchlorate, sodium hexafluoroarsenate, sodium trifluoroacetate, sodium tetraphenylborate, and sodium bis(trifluoromethanesulfonyl)imide;
a mass content of the electrolyte salt, based on a total mass of the electrolyte being 100%, is 8%-14%;
the auxiliary additive including at least one selected from the group consisting of 1,4-butane sultone, 1,3-propylene sultone, ethylene sulfate, and fluoroethylene carbonate;
a mass content of the auxiliary additive, based on the total mass of the electrolyte being 100%, is 2.5%-10%; and
the non-aqueous organic solvent including at least one selected from the group consisting of carbonate esters having 3-5 carbon atoms, carboxylic esters having 2-6 carbon atoms, and ethers having 4-10 carbon atoms.

The positive electrode active material includes at least one selected from the group consisting of layered transition metal oxides, Prussian-type compounds, phosphate-type compounds, and sulfate-type compounds;
the negative electrode active substance layer includes a negative electrode active substance, the negative electrode active substance including one or more selected from the group consisting of carbon-based materials, silicon-based materials, and tin-based materials.

### Beneficial Effects

In the sodium-ion battery provided in the present application, a represents a mass content of the sodium-supplementing additive, based on a total mass of the sodium-supplementing additive and the positive electrode active material being 100%. A synergistic effect is achieved among the sodium-supplementing additive, the sodium salt additive, and the negative electrode active material. Moreover, the mass content (a) of the sodium-supplementing additive, the mass content (b) of the sodium salt additive added into the electrolyte, and the particle size (c) of the negative electrode active material have a specific relationship. When a, b, and c satisfy the relationship of 0.3≤a/(b+c)≤1.5, the optimal electrical conductivity of the positive electrode can be ensured while effectively improving the ionic conductivity of the electrolyte and the diffusion and transport rate of ions within the negative electrode material, thereby effectively reducing the overall internal resistance of the battery and improving both the initial coulombic efficiency and the cycle performance of the battery. In addition, the sodium salt additive in the electrolyte is involved in the formation of interfacial films on both the positive and negative electrodes, effectively protecting the stability of the negative electrode during testing and further enhancing the cycle performance.

### DETAILED DESCRIPTION OF THE EMBODIMENTS

In order to make the technical problems to be solved, technical solutions and beneficial effects of the present disclosure more clear, the present disclosure will be further explained in detail below with reference to the embodiments. It should be understood that the specific embodiments described here are intended only to illustrate the present disclosure and are not intended to limit it in any way.

In one aspect, the present application provides a sodium-ion battery, including a non-aqueous electrolyte, a positive electrode, and a negative electrode. The non-aqueous electrolyte includes an additive, the additive including a sodium salt additive, the positive electrode includes a positive electrode active substance layer, the positive electrode active substance layer including a sodium-supplementing additive and a positive electrode active material, the sodium-supplementing additive being a sodium-rich transition metal oxide, the negative electrode includes a negative electrode active material;
the sodium-ion battery satisfies the following relationship:

$$0.3 \leq a / ( b + c ) \leq 1.5 , and 5 \leq a \leq 10 , 1 \leq b \leq 10 , 2 \leq c \leq 12 ;$$

a total mass of the sodium-supplementing additive and the positive electrode active material is 100%, a represents a mass content of the sodium-supplementing additive, in %;
b represents a mass content of the sodium salt additive in the non-aqueous electrolyte, in %; and
c represents a particle size of the negative electrode active material, in μm.

In sodium-ion batteries where a sodium-rich transition metal oxide is used as a sodium-supplementing additive, the sodium-supplementing additive exhibits poor electrical conductivity, high impedance, high reactivity, and a tendency to decompose and generate gas, the prepared batteries exhibit low initial coulombic efficiency and poor cycle performance. The inventors, after extensive research, discovered that when the total mass of the sodium-supplementing additive and the positive electrode active material is 100%, with a representing the mass content of the sodium-supplementing additive, a synergistic effect is achieved among the sodium-supplementing additive, the sodium salt additive, and the negative electrode active material. A specific relationship exists among the mass content (a) of the sodium-supplementing additive, the mass content (b) of the sodium salt additive added into the electrolyte, and the particle size (c) of the negative electrode active material, when a, b, and c satisfy the specific relationship of 0.3≤a/(b+c)≤1.5, the optimal electrical conductivity of the positive electrode can be ensured while effectively improving the ionic conductivity of the electrolyte and the diffusion and transport rate of ions within the negative electrode material. As a result, the overall internal resistance of the battery can be effectively reduced, and both the initial coulombic efficiency and the cycle performance of the battery can be improved. In addition, the sodium salt additive in the electrolyte is involved in the formation of interfacial films on both the positive and negative electrodes, effectively protecting the stability of the negative electrode during testing and further enhancing the cycle performance.

In some preferred embodiments, the sodium-ion battery satisfies the following relationship: 0.5≤a/(b+c)≤1.2.

For the sodium-ion battery satisfying the relationship of 0.5≤a/(b+c)≤1.2, the positive electrode exhibits higher electrical conductivity, and the ionic conductivity of the electrolyte is significantly improved, thereby enhancing the diffusion and transport rate of sodium ions within the negative electrode active material. As a result, the overall internal resistance of the battery can be effectively reduced, and both the initial coulombic efficiency and the cycle performance of the battery can be improved. In addition, the sodium salt additive added into the electrolyte also participates in the film formation on the negative electrode, enabling the formation of an interfacial film with higher structural stability on the electrode surface, which prevents residual by-products of the sodium-supplementing additive from damaging the positive and negative electrodes, effectively maintaining the stability of the negative electrode during testing and further improving the cycle performance.

Specifically, the value of a/(b+c) in the sodium-ion battery may be 0.3, 0.5, 0.6, 0.8, 1.0, 1.2, 1.4, 1.5, provided that the value of a/(b+c) falls within the range of 0.3-1.5. Specifically, the mass content (b) of the sodium salt additive in the non-aqueous electrolyte is in a range of 1%-10%. Such a configuration can improve the overall ionic conductivity of the electrolyte and also participate in the formation of interfacial films on the positive and negative electrodes, thereby protecting the positive and negative electrodes, effectively addressing the problems of poor electrical conductivity of the sodium-supplementing additive and damage to the positive and negative electrodes caused by residual by-products, improving battery performance, and enhancing the cycle performance. When the mass content (b) of the sodium salt additive in the non-aqueous electrolyte is less than 1%, the improvement in the ionic conductivity of the electrolyte is insignificant, and the additive cannot effectively participate in the formation of electrode interfacial films. When b is greater than 10%, the excessive mass content of the sodium salt additive in the electrolyte leads to the formation of a thicker interfacial film at the electrode interface, resulting in a decreased sodium-ion transport rate and increased battery impedance. Specifically, the mass content (b) of the sodium salt additive in the non-aqueous electrolyte may be 1%, 1.5%, 2%, 3%, 4%, 5%, 6%, 7%, 8%, 9%, 10%, provided that b is within the range of 1%-10%.

In some preferred embodiments, the mass content (b) of the sodium salt additive in the non-aqueous electrolyte is in a range of 2%-6%.

Within the above preferred range, the sodium salt additive in the electrolyte can improve the overall ionic conductivity of the electrolyte while forming an interfacial film of moderate thickness and stable structure at the interfaces of the positive and negative electrodes, thereby effectively addressing the problems of poor electrical conductivity of the sodium-supplementing additive and damage to the positive and negative electrodes caused by residual by-products, improving the battery performance and enhancing the cycle performance of the battery.

In some embodiments, the sodium salt additive includes one or more selected from the group consisting of sodium bis(fluorosulfonyl)imide (NaFSI), sodium difluoro (oxalato) borate (NaODFB), and sodium difluorophosphate (NaPO₂F₂).

In some embodiments, the total mass of the sodium-supplementing additive and the positive electrode active material is 100%, and the mass content (a) of the sodium-supplementing additive is in a range of 5%-10%.

Given that the sodium-supplementing additive has poor electrical conductivity and generates residual by-products after the reaction, when the mass content (a) of the sodium-supplementing additive exceeds 10%, the overall performance of the positive electrode material deteriorates. When the mass content (a) of the sodium-supplementing additive is less than 5%, the effect of sodium supplementation is not achieved. In the sodium-ion battery, when the total mass of the sodium-supplementing additive and the positive electrode active material is 100%, and the mass content (a) of the sodium-supplementing additive is within the range of 5%-10%, the sodium-supplementing additive can effectively supplement sodium ions, improve the electrical conductivity of the positive electrode, and reduce the amount of by-products remaining after the reaction of the sodium-supplementing additive, thereby improving the initial coulombic efficiency and cycle performance of the battery. Specifically, a may be 5%, 5.5%, 6%, 6.4%, 7.0%, 7.3%, 7.6%, 8.0%, 9%, 10%, provided that the value of a is within the range of 5%-10%.

In some preferred embodiments, the total mass of the sodium-supplementing additive and the positive electrode active material is 100%, and the mass content (a) of the sodium-supplementing additive is in a range of 5.5%-9%.

Within the above preferred range, the sodium-supplementing additive in the sodium-ion battery can provide an effect of sodium supplementation, while also improving the electrical conductivity of the positive electrode sheet, thereby enhancing the initial coulombic efficiency and cycle performance of the battery.

In some embodiments, the sodium-rich transition metal oxide includes a compound represented by Formula 1,

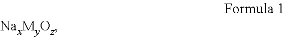

where 0.2<x/y<9, 0<y<6, 2≤z≤9, and M is selected from one or more of Nb, V, Ta, Mn, Fe, Cr, Co, Ni, Cu, Zn, Mg, Ti, Si, Sn, Ce, and Zr.

In some preferred embodiments, the sodium-rich transition metal oxide includes one or more selected from the group consisting of Na₅NbO₅, Na₃NbO₄, Na₄Nb₂O₇, Na₅VO₅, Na₃VO₄, and Na₃TaO₄. It should be understood that the types of the sodium-rich transition metal oxides are not limited to those described above in the present application.

In some embodiments, the particle size (c) of the negative electrode active material is in a range of 2 μm-12 μm.

The particle size range from 2 μm to 12 μm for the negative electrode active material ensures a relatively rapid ion transport within and between the particles of the active material, thereby further mitigating the degradation in rate performance caused by the sodium-supplementing additive and improving the cycle performance of the battery. When the particle size (c) of the negative electrode active material is greater than 12 μm, the internal resistance of the battery increases, resulting in poor cycle performance. When the particle size (c) is less than 2 μm, excessively small particle size reduces the initial coulombic efficiency of the battery. Specifically, the particle size (c) of the negative electrode active material may be 3 μm, 4 μm, 5 μm, 5.5 μm, 6 μm, 7.5 μm, 8 μm, 9 μm, 10 μm, or 12 μm, provided that c is within the range of 2-12 μm.

In some preferred embodiments, the particle size (c) of the negative electrode active material is in a range of 3 μm-9 μm.

Within the above preferred range, the particle size (c) of the negative electrode active material can further improve the transport efficiency of sodium ions, thereby further enhancing the cycle performance of the battery.

In some embodiments, the additive further includes 1,3-propane sultone, and the mass content of the 1,3-propane sultone in the non-aqueous electrolyte is in a range of 0.5%-2%.

Specifically, 1,3-propane sultone (PS) with a mass content of 0.5%-2% in the electrolyte can effectively suppress side reactions and the dissolution and deposition of metal ions on the surface of the positive electrode, stabilize the crystal structure of the positive electrode, effectively reduce the internal resistance and gas generation of the battery, and improve the cycle performance. Specifically, when the PS content in the electrolyte is lower than 0.5%, it cannot effectively suppress the dissolution and deposition of metal ions at the positive electrode interface. When the PS content in the electrolyte exceeds 2%, the thickness of the electrode interfacial film formed in the electrolyte increases, resulting in increased battery impedance. Specifically, the mass content of 1,3-propane sultone in the electrolyte may be 0.5%, 0.8%, 1.0%, 1.2%, 1.4%, 1.5%, 1.7%, 1.9%, or 2.0%, provided that the value falls within the range of 0.5%-2%.

In some preferred embodiments, the mass content of 1,3-propane sultone in the non-aqueous electrolyte is in a range of 1%-2%.

Within this preferred range, the 1,3-propane sultone can not only effectively suppress the dissolution and deposition of metal ions at the positive electrode interface, but also participate in the formation of an interfacial film with structural stability, thereby reducing the internal resistance and gas generation of the battery.

In some embodiments, the non-aqueous electrolyte further includes an electrolyte salt, and the electrolyte salt includes at least one selected from the group consisting of sodium hexafluorophosphate, sodium trifluoromethanesulfonimide, sodium trifluoromethanesulfonate, sodium tetrafluoroborate, sodium perchlorate, sodium hexafluoroarsenate, sodium trifluoroacetate, sodium tetraphenylborate, and sodium bis(trifluoromethanesulfonyl)imide.

The mass content of the electrolyte salt, based on a total mass of the electrolyte being 100%, is 8%-14%.

The electrolyte salt in the electrolyte exhibits high solubility and easy dissociation in a non-aqueous organic solvent, ensuring high ionic conductivity of the electrolyte and promoting the redox reactions of the battery.

In some embodiments, the non-aqueous electrolyte further includes an auxiliary additive, and the auxiliary additive includes at least one selected from the group consisting of 1,4-butane sultone, 1,3-propylene sultone (RPS), ethylene sulfate (DTD), and fluoroethylene carbonate; a mass content of the auxiliary additive, based on the total mass of the electrolyte of 100%, is 2.5%-10%.

In some embodiments, the non-aqueous electrolyte further includes a non-aqueous organic solvent, and the non-aqueous organic solvent includes at least one selected from the group consisting of carbonate esters having 3-5 carbon atoms, carboxylic esters having 2-6 carbon atoms, and ethers having 4-10 carbon atoms.

Preferably, the carbonate ester solvents having 3-5 carbon atoms include cyclic carbonate esters or linear carbonate esters having 3-5 carbon atoms, and the cyclic carbonate includes but is not limited to at least one of ethylene carbonate (EC), vinylene carbonate (VC), vinyl ethylene carbonate (VEC), propylene carbonate (PC), γ-butyrolactone (GBL) and butylene carbonate (BC); the linear carbonate esters may be, but not limited to, dimethyl carbonate (DMC), ethyl methyl carbonate (EMC), diethyl carbonate (DEC) and dipropyl carbonate (DPC).

Preferably, the carboxylic esters having 2-6 carbon atoms include, but are not limited to, methyl acetate (MA), ethyl acetate (EA), propyl acetate (EP), butyl acetate, and propyl propionate (PP). As a preferred embodiment, the non-aqueous electrolyte of the sodium-ion battery further includes vinylene carbonate (VC), vinyl ethylene carbonate (VEC), and fluoroethylene carbonate (FEC).

Preferably, the ether solvents having 4-10 carbon atoms include cyclic ethers or linear ethers having 4-10 carbon atoms. The cyclic ethers include, but are not limited to, 1,3-dioxolane (DOL), 1,4-dioxane (DX), tetrahydrofuran (THF), 2-methyltetrahydrofuran (2-CH₃-THF) and 2-(trifluoromethyl)tetrahydrofuran (2-CF₃-THF); the linear ethers include, but are not limited to, dimethoxymethane (DMM), 1,2-dimethoxyethane (DME) and diethylene glycol dimethyl ether (TEGDME).

In some embodiments, the positive electrode active substance layer includes a positive electrode active material, the positive electrode active material includes at least one selected from the group consisting of layered transition metal oxides, Prussian-type compounds, phosphate-type compounds, and sulfate-type compounds.

The negative electrode includes a negative electrode active material, the negative electrode active material includes one or more selected from the group consisting of carbon-based materials, silicon-based materials, and tin-based materials. The carbon-based material includes at least one selected from the group consisting of hard carbon, soft carbon, carbon nanotubes, graphite, graphene, expanded graphite, or mesocarbon microbeads.

In some embodiments, the layered transition metal oxide is represented by the chemical formula NaₙLₘOᵣ, where 0<n≤1, 0<m≤1, 1<r≤2, and L is selected from at least one of Cr, Fe, Co, Ni, Cu, Mn, Sn, Mo, Sb, and V.

In preferred embodiments, the layered transition metal oxide is represented by the chemical formula NaₚNiₘMnₙM₍₁₋ₘ₋ₙ₎O_{q}, where 0<p≤1, 0≤m<1, 0<m+n<1, and 1<q≤2.

In more preferred embodiments, the positive electrode active material is represented by the chemical formula Na_{p′}Ni_{m′}Mn_{n′}Fe_{(1-m′-n′)}O₂, where 0<p′≤1, 0≤m′<1, 0<m′+n′<1. Preferably NaNi_{0.3}Mn_{0.3}Fe_{0.4}O₂, NaNi_{0.4}Mn_{0.4}Fe_{0.2}O₂, or NaNi_{0.5}Mn_{0.35}Fe_{0.15}O₂.

In more preferred embodiments, the layered transition metal oxide is selected from at least one compound represented by the chemical formula NaNiₘCoₙMnₚO₂ (m+n+p=1, 0≤m≤1, 0≤n≤1, 0≤p≤1).

In some embodiments, the Prussian-type compound is represented by the molecular formula Na_{x′}M[M′(CN)₆]_{y′}·z′H₂O, where M is a transition metal, M′ is a transition metal, 0<x′≤2, 0<y′≤1, and 0<z′≤20.

In more preferred embodiments, the Prussian-type compound is represented by the molecular formula Na_{x′}Mn[Fe(CN)₆]_{y′}·z′H₂O or Na_{x′}Fe[Fe(CN)₆]_{y′}·z′H₂O, where 0<x′≤2, 0<y′≤1, and 0<z′≤20.

In some embodiments, the phosphate-type compound is represented by the chemical formula Na₃(RO_{1-x″}PO₄)₂F_{1+2x″} or Na₂R′PO₄F, where 0≤x″≤1, R is selected from at least one of Al, V, Ge, Fe, and Ga, and R′ is selected from at least one of Fe and Mn.

In more preferred embodiments, the phosphate-type compound is represented by the chemical formula Na₃(VPO₄)₂F₃, Na₃(VOPO₄)₂F, Na₂FePO₄F, or Na₂MnPO₄F.

In some embodiments, the sulfate-type compound is represented by the chemical formula Na₂A(SO₄)₂·2H₂O, where A is selected from at least one of Cr, Fe, Co, Ni, Cu, Mn, Sn, Mo, Sb, and V.

The following embodiments are provided to further illustrate the present disclosure.

### Embodiment 1

This embodiment is provided to illustrate the sodium-ion battery disclosed in the present disclosure.

(1) Preparation of positive electrode: The positive electrode active material NaNi_{0.3}Fe_{0.3}Mn_{0.4}O₂, sodium-supplementing additive Na₅NbO₅, conductive carbon black Super-P, and binder polyvinylidene fluoride (PVDF) were mixed in a mass ratio of 88.825:6.175:2:3, and then dispersed in an appropriate amount of N-methyl-2-pyrrolidone (NMP) to obtain a positive electrode slurry. The slurry was evenly coated on both sides of an aluminum foil. After being dried, calendered, and vacuum-dried, an aluminum tab was welded using an ultrasonic welder to obtain the positive electrode sheet. Based on the total mass of the positive electrode active material and the sodium-supplement additive being 100%, the mass content of the sodium-supplement additive was denoted as a, and a was 6.5%.

(2) Preparation of negative electrode: The negative electrode active material hard carbon, conductive carbon black Super-P, binder styrene-butadiene rubber (SBR), and carboxymethyl cellulose (CMC) were mixed in a mass ratio of 94:1:2.5:2.5, and then dispersed in an appropriate amount of deionized water to obtain a negative electrode slurry. The slurry was coated on both sides of a copper foil. After being dried, calendered, and vacuum-dried, a nickel tab was welded using an ultrasonic welder to obtain a negative electrode sheet. The particle size of the hard carbon serving as the negative electrode active material was denoted as c, and the specific value of c is shown in Table 1.

(3) Preparation of electrolyte: Ethylene carbonate (EC), propylene carbonate (PC), and diethyl carbonate were mixed in a mass ratio of EC:PC:DEC=10:15:75. Then, sodium hexafluorophosphate with a mass content of 12% was added, followed by the addition of a sodium salt additive, sodium difluoro (oxalato) borate, with a mass content of b, and 1,3-propane sultone (PS). Finally, an auxiliary additive was added to prepare the electrolyte. The specific type and mass content of the auxiliary additive, the specific value of b, and the mass content of 1,3-propane sultone are shown in Table 1.

(4) Preparation of sodium-ion battery: A separator was placed between the positive electrode sheet and the negative electrode sheet prepared as described above. The sandwich structure formed by the positive electrode sheet, the negative electrode sheet, and the separator was then wound, flattened, and placed into an aluminum pouch, and a sodium-ion battery was obtained after assembly.

### Embodiments 2-30 and Comparative Examples 1-11

Embodiments 2-30 and Comparative Examples 1-11 differ from Embodiment 1 in the values of a, c, and b, as well as in the type and mass content of the auxiliary additive and the mass content of the 1,3-propane sultone, as shown in Table 1. The remaining preparation steps were the same as those in Embodiment 1. In the auxiliary additive, DTD refers to ethylene sulfate, and RPS refers to 1,3-propylene sultone.

TABLE 1
Parameters of Embodiments and Comparative Examples

| | | | | | Particle | Mass | | |
|---|---|---|---|---|---|---|---|---|
| | | | | | size (c) of | content of | Types | |
| | Types of | Mass content | Types of | Mass content | negative | 1,3-propane | and mass | |
| | sodium- | (a) of sodium- | sodium | (b) of sodium | electrode | sultone in | content of | |
| | supplementing | supplementing | salt | salt additive in | active | electrolyte | auxiliary | |
| Group | additive | additive (%) | additive | electrolyte (%) | material (μm) | (%) | additive (%) | a/(b + c) |
| Embodiment | Na₅NbO₅ | 6.5 | NaODFB | 3 | 5.5 | 1.0 | / | 0.765 |
| 1 | | | | | | | | |
| Embodiment | Na₅NbO₅ | 5.0 | NaODFB | 3 | 5.5 | 1.0 | / | 0.588 |
| 2 | | | | | | | | |
| Embodiment | Na₅NbO₅ | 8.0 | NaODFB | 3 | 5.5 | 1.0 | / | 0.941 |
| 3 | | | | | | | | |
| Embodiment | Na₅NbO₅ | 10.0 | NaODFB | 3 | 5.5 | 1.0 | / | 1.176 |
| 4 | | | | | | | | |
| Embodiment | Na₅NbO₅ | 6.5 | NaODFB | 1 | 5.5 | 1.0 | / | 1.000 |
| 5 | | | | | | | | |
| Embodiment | Na₅NbO₅ | 6.5 | NaODFB | 6 | 5.5 | 1.0 | / | 0.565 |
| 6 | | | | | | | | |
| Embodiment | Na₅NbO₅ | 6.5 | NaODFB | 2 | 5.5 | 1.0 | / | 0.867 |
| 7 | | | | | | | | |
| Embodiment | Na₅NbO₅ | 6.5 | NaODFB | 8 | 5.5 | 1.0 | / | 0.481 |
| 8 | | | | | | | | |
| Embodiment | Na₅NbO₅ | 6.5 | NaODFB | 10 | 5.5 | 1.0 | / | 0.419 |
| 9 | | | | | | | | |
| Embodiment | Na₅NbO₅ | 6.5 | NaODFB | 3 | 2.0 | 1.0 | / | 1.300 |
| 10 | | | | | | | | |
| Embodiment | Na₅NbO₅ | 6.5 | NaODFB | 3 | 3.0 | 1.0 | / | 1.083 |
| 11 | | | | | | | | |
| Embodiment | Na₅NbO₅ | 6.5 | NaODFB | 3 | 9.0 | 1.0 | / | 0.542 |
| 12 | | | | | | | | |
| Embodiment | Na₅NbO₅ | 6.5 | NaODFB | 3 | 12.0 | 1.0 | / | 0.433 |
| 13 | | | | | | | | |
| Embodiment | Na₅NbO₅ | 6.0 | NaODFB | 10 | 10.0 | 1.0 | / | 0.300 |
| 14 | | | | | | | | |
| Embodiment | Na₅NbO₅ | 9.0 | NaODFB | 4 | 2.0 | 1.0 | / | 1.500 |
| 15 | | | | | | | | |
| Embodiment | Na₅NbO₅ | 6.0 | NaODFB | 2 | 3.0 | 1.0 | / | 1.200 |
| 16 | | | | | | | | |
| Embodiment | Na₅NbO₅ | 6.5 | NaODFB | 3 | 5.5 | 0 | / | 0.765 |
| 17 | | | | | | | | |
| Embodiment | Na₄Nb₂O₇ | 6.5 | NaODFB | 3 | 5.5 | 1.0 | / | 0.765 |
| 18 | | | | | | | | |
| Embodiment | Na₅VO₅ | 6.5 | NaODFB | 3 | 5.5 | 1.0 | / | 0.765 |
| 19 | | | | | | | | |
| Embodiment | Na₃VO₄ | 6.5 | NaODFB | 3 | 5.5 | 1.0 | / | 0.765 |
| 20 | | | | | | | | |
| Embodiment | Na₃TaO₄ | 6.5 | NaODFB | 3 | 5.5 | 1.0 | / | 0.765 |
| 21 | | | | | | | | |
| Embodiment | Na₅NbO₅ | 6.5 | NaFSI | 3 | 5.5 | 1.0 | / | 0.765 |
| 22 | | | | | | | | |
| Embodiment | Na₅NbO₅ | 6.5 | NaPO₂F₂ | 3 | 5.5 | 1.0 | / | 0.765 |
| 23 | | | | | | | | |
| Embodiment | Na₅NbO₅ | 6.5 | NaODFB | 3 | 5.5 | 0.5 | / | 0.765 |
| 24 | | | | | | | | |
| Embodiment | Na₅NbO₅ | 6.5 | NaODFB | 3 | 5.5 | 1.5 | / | 0.765 |
| 25 | | | | | | | | |
| Embodiment | Na₅NbO₅ | 6.5 | NaODFB | 3 | 5.5 | 2.0 | / | 0.765 |
| 26 | | | | | | | | |
| Embodiment | Na₅NbO₅ | 6.5 | NaODFB | 3 | 5.5 | 0.4 | / | 0.765 |
| 27 | | | | | | | | |
| Embodiment | Na₅NbO₅ | 6.5 | NaODFB | 3 | 5.5 | 2.5 | / | 0.765 |
| 28 | | | | | | | | |
| Embodiment | Na₅NbO₅ | 6.5 | NaODFB | 3 | 5.5 | 1.0 | DTD/3 | 0.765 |
| 29 | | | | | | | | |
| Embodiment | Na₅NbO₅ | 6.5 | NaODFB | 3 | 5.5 | 1.0 | RPS/3.5 | 0.765 |
| 30 | | | | | | | | |
| Comparative | / | 0 | / | 0 | 5.5 | 1.0 | / | 0 |
| Example 1 | | | | | | | | |
| Comparative | Na₅NbO₅ | 6.5 | / | 0 | 5.5 | 1.0 | / | 1.182 |
| Example 2 | | | | | | | | |
| Comparative | / | 0 | NaODFB | 2 | 5.5 | 1.0 | / | 0.000 |
| Example 3 | | | | | | | | |
| Comparative | Na₅NbO₅ | 4.0 | NaODFB | 2 | 5.0 | 1.0 | / | 0.571 |
| Example 4 | | | | | | | | |
| Comparative | Na₅NbO₅ | 11.0 | NaODFB | 2 | 5.0 | 1.0 | / | 1.571 |
| Example 5 | | | | | | | | |
| Comparative | Na₅NbO₅ | 6.5 | NaODFB | 0.5 | 5.5 | 1.0 | / | 1.083 |
| Example 6 | | | | | | | | |
| Comparative | Na₅NbO₅ | 6.5 | NaODFB | 12 | 5.5 | 1.0 | / | 0.371 |
| Example 7 | | | | | | | | |
| Comparative | Na₅NbO₅ | 6.5 | NaODFB | 6 | 1.9 | 1.0 | / | 0.823 |
| Example 8 | | | | | | | | |
| Comparative | Na₅NbO₅ | 6.5 | NaODFB | 2 | 13.0 | 1.0 | / | 0.433 |
| Example 9 | | | | | | | | |
| Comparative | Na₅NbO₅ | 5.0 | NaODFB | 10 | 10.0 | 1.0 | / | 0.250 |
| Example 10 | | | | | | | | |
| Comparative | Na₅NbO₅ | 10.0 | NaODFB | 1 | 2.0 | 1.0 | / | 3.333 |
| Example 11 | | | | | | | | |

### Performance Test

The sodium-ion battery prepared according to the above embodiments and comparative examples was subjected to the following performance tests.

### 1. Initial Coulombic Efficiency Test:

The batteries were placed at 25° C. for 2 hours, then charged to 4.0 V at a constant current of 0.5 C, followed by constant voltage charging until the current was 0.03 C. The charge capacity was recorded as C1. Subsequently, the batteries were discharged to 1.5V at a constant current of 1 C, and the discharge capacity was recorded as C2.

$$initial coulombic efficiency ( \% ) = ( C 2 / C 1 ) \times 100 \% .$$

### 2. High-Temperature Cycle Performance Test:

The formed batteries were placed at 45° C. for 2 hours, then charged to 4.0V at a constant current of 0.5 C, followed by constant voltage charging until the current was 0.03 C. The batteries were discharged to 1.5V at a constant current of 1 C, and the discharge capacity in the first cycle was recorded as C3. After 400 cycles of charge and discharge, the discharge capacity in the 400th cycle was recorded as C4.

Capacity retention after 400 cycles at high temperature (%)=(C4/C3)×100%.

The gas generation of the batteries was tested by a method in which the gas generation was determined based on the weight of the displaced liquid. In the first charge and discharge cycle described above, after the batteries were fully charged, the weight of the displaced liquid was measured and recorded as G1. After the batteries were fully charged in the 400th cycle, the weight of the displaced liquid was measured and recorded as G2.

Gas generation amount of the batteries after 400 cycles at high temperature (mL)=G2-G1.

### 3. Cycle Performance Test at Room Temperature:

The formed batteries were placed at 25 C for 2 hours, then charged to 4.0V at a constant current of 0.5 C, followed by constant voltage charging until the current was 0.03 C. The batteries were discharged to 1.5V at a constant current of 1 C, and the discharge capacity in the first cycle was recorded as C3. After 400 cycles of charge and discharge, the discharge capacity in the 400th cycle was recorded as C4.

$$Capacity retention after 400 cycles at room temperature ( \% ) = ( C 4 / C 3 ) \times 100 \% .$$

### 4. Electrical Conductivity Test:

The electrical conductivity test was performed in accordance with the standard HG/T 4067-2015. A DDSJ-308A conductivity meter was used, with a measurement range of 0.000 μS/cm to 199.9 mS/cm. Type 1 and Type 10 platinum-black electrodes were employed. Before testing, calibration was performed at 25° C. with a potassium chloride standard solution of C(KCl)=0.1 mol/L (standard value 12.88 mS/cm). During testing, the electrode and temperature sensor were inserted into a beaker containing the electrolyte. The beaker was then placed in a thermostatic bath until the temperature reached 25° C., and the indicated value was read once it became stable.

5. DCIR Test after Capacity Grading

At 25° C., the batteries were left to stand for 5 minutes, and then charged at a constant current of 1 C to the upper cut-off voltage, followed by constant voltage charging until the current was less than or equal to 0.05 C. After the above charging process, the state of charge (SOC) of the battery was 100%. The batteries were then left to stand for another 5 minutes and discharged at a constant current of 1 C to adjust the state of charge SOC of the sodium-ion secondary battery to 50%. After standing for 30 minutes, the batteries were discharged at a constant current of 1 C for 10 seconds. The voltage before discharge was recorded as U1, and the voltage after discharge was recorded as U2. Accordingly, the DCIR of the battery=(U1−U2)/1 C.

### 6. Internal Resistance of the Battery

The internal resistance of the battery was measured after the first full charge. Specifically, at 25° C., the battery was charged at a constant current of 1 C to the upper cut-off voltage, followed by constant voltage charging until the current was less than or equal to 0.05 C. After the above charging process, the state of charge (SOC) of the battery was 100%, and the internal resistance of the battery was then measured.

The test results are shown in Tables 2-5.

TABLE 2
Performance results of Embodiments 1-17 and Comparative Examples 1-11

| | | | | Capacity | | Gas | |
|---|---|---|---|---|---|---|---|
| | Electrical | | DCIR | Retention | Capacity | Generation | Internal |
| | Conductivity | Initial | after | after 400 | Retention | Amount | Resistance |
| | of | Coulombic | Capacity | Cycles at | after 400 | after 400 | of the |
| | Electrolyte | Efficiency | Grading | 25° C. | Cycles at | Cycles at | Battery |
| Group | (mS/cm) | (%) | (mΩ) | (%) | 45° C. (%) | 45° C. (mL) | (mΩ) |
| Embodiment | 7.78 | 90.4 | 44.4 | 94.2 | 92.3 | 14.0 | 16.6 |
| 1 | | | | | | | |
| Embodiment | 7.78 | 88.5 | 60.9 | 91.2 | 89.2 | 19.0 | 20.4 |
| 2 | | | | | | | |
| Embodiment | 7.78 | 90.1 | 61.3 | 93.9 | 91.8 | 18.5 | 17.3 |
| 3 | | | | | | | |
| Embodiment | 7.78 | 87.7 | 62.6 | 91.5 | 89.7 | 18.9 | 21.0 |
| 4 | | | | | | | |
| Embodiment | 6.23 | 86.9 | 69.1 | 91.0 | 89.1 | 20.1 | 19.8 |
| 5 | | | | | | | |
| Embodiment | 8.22 | 89.4 | 59.8 | 93 | 91.2 | 18.2 | 17.4 |
| 6 | | | | | | | |
| Embodiment | 8.35 | 89.1 | 62.8 | 93.8 | 91.9 | 19.2 | 17.1 |
| 7 | | | | | | | |
| Embodiment | 8.41 | 87.0 | 58.6 | 91.4 | 89.5 | 19.8 | 19.5 |
| 8 | | | | | | | |
| Embodiment | 8.52 | 87.2 | 56.3 | 91.2 | 89.2 | 20.5 | 19.1 |
| 9 | | | | | | | |
| Embodiment | 7.78 | 88.5 | 68.2 | 91.5 | 89.6 | 20.4 | 19.8 |
| 10 | | | | | | | |
| Embodiment | 7.78 | 89.7 | 47.8 | 93.3 | 91.4 | 14.1 | 17.0 |
| 11 | | | | | | | |
| Embodiment | 7.78 | 89.8 | 49.3 | 93.0 | 91.2 | 14.5 | 18.4 |
| 12 | | | | | | | |
| Embodiment | 7.78 | 87.5 | 70.1 | 90.8 | 88.9 | 22.0 | 22.5 |
| 13 | | | | | | | |
| Embodiment | 8.32 | 87.0 | 72.1 | 90.2 | 88.3 | 23.0 | 22.9 |
| 14 | | | | | | | |
| Embodiment | 7.84 | 88.2 | 70.2 | 91.2 | 89.3 | 20.1 | 20.7 |
| 15 | | | | | | | |
| Embodiment | 7.95 | 89.5 | 49.8 | 93.1 | 91.1 | 16.8 | 17.4 |
| 16 | | | | | | | |
| Embodiment | 7.71 | 88.3 | 68.7 | 90.8 | 88.9 | 60.5 | 19.8 |
| 17 | | | | | | | |
| Comparative | 7.01 | 70.4 | 98.7 | 67.5 | 65.2 | 55.3 | 39.8 |
| Example 1 | | | | | | | |
| Comparative | 7.01 | 74.3 | 110.3 | 70.6 | 68.1 | 58.3 | 42.5 |
| Example 2 | | | | | | | |
| Comparative | 7.45 | 69.4 | 100.7 | 68.5 | 66.2 | 58.3 | 43.8 |
| Example 3 | | | | | | | |
| Comparative | 7.45 | 74.3 | 89.2 | 71.9 | 68.3 | 32.0 | 43.2 |
| Example 4 | | | | | | | |
| Comparative | 7.45 | 75.1 | 140.8 | 61.6 | 59.1 | 58.0 | 50.4 |
| Example 5 | | | | | | | |
| Comparative | 6.09 | 80.1 | 132.0 | 78.3 | 77.5 | 31.0 | 56.2 |
| Example 6 | | | | | | | |
| Comparative | 8.71 | 78.9 | 117.0 | 72.7 | 70.9 | 33.0 | 48.9 |
| Example 7 | | | | | | | |
| Comparative | 8.21 | 69.7 | 110.7 | 72.1 | 69.8 | 40.6 | 44.2 |
| Example 8 | | | | | | | |
| Comparative | 7.40 | 71.8 | 106.5 | 70.8 | 68.3 | 39.0 | 56.6 |
| Example 9 | | | | | | | |
| Comparative | 8.34 | 68.2 | 100.5 | 68.5 | 66.0 | 40.2 | 47.8 |
| Example 10 | | | | | | | |
| Comparative | 6.24 | 64.3 | 112.4 | 67.5 | 65.3 | 42.0 | 50.5 |
| Example 11 | | | | | | | |

According to Tables 1 and 2, Embodiment 1 was compared with Comparative Examples 1-3. In Comparative Example 1, no sodium-supplementing additive or sodium salt additive was added. The battery exhibited low initial coulombic efficiency, high internal resistance, and poor cycle performance. In Comparative Example 2, a sodium-supplementing additive was added, and the initial coulombic efficiency of the battery was slightly improved; however, the overall performance of the battery remained poor. In Comparative Example 3, no sodium-supplementing additive was added, while a sodium salt additive was added into the electrolyte. The electrical conductivity of the electrolyte was improved, but the battery exhibited low initial coulombic efficiency, high internal resistance, and poor cycle performance. These results indicate that adding a sodium-supplementing additive to the battery can compensate for sodium loss and improve the initial coulombic efficiency, while adding a sodium salt additive helps enhance the electrical conductivity of the electrolyte. Embodiment 7 was compared with Comparative Examples 4 and 5. When the mass content (a) of the sodium-supplementing additive added to the battery was lower than 5%, the initial coulombic efficiency of the battery was low. When the mass content (a) was higher than 10%, the battery exhibited low initial coulombic efficiency, high DCIR, high internal resistance, and poor cycle performance. It is speculated that when the mass content (a) of the sodium-supplementing additive exceeds 10%, the additive decomposes and residual by-products may damage the interfacial film, thereby increasing the internal resistance of the battery and reducing its initial coulombic efficiency and cycle performance. Embodiment 1 was compared with Comparative Examples 5 and 6. When the mass content (b) of the sodium salt additive in the electrolyte was less than 1%, the electrical conductivity of the electrolyte was low and the internal resistance of the battery increased. When the mass content (b) exceeded 10%, although the electrical conductivity of the electrolyte was improved, the battery exhibited high internal resistance and poor cycle performance. It is speculated that when the mass content (b) of the sodium salt additive in the electrolyte is in the range of 1%-10%, the electrical conductivity of the electrolyte can be improved, and the additive can participate in the formation of the electrode interfacial film to protect both the positive and negative electrodes, thereby effectively addressing the problem that a sodium-supplementing additive exhibits poor electrical conductivity and that residual by-products may damage the positive and negative electrodes. Embodiments 6 and 7 were compared with Comparative Examples 8 and 9. The results showed that the battery exhibited low initial coulombic efficiency, high DCIR, high internal resistance, low capacity retention during cycle, and excessive gas generation when the particle size (c) of the negative electrode active material was smaller than 2 μm or larger than 12 μm. Embodiments 1-17 were compared with Comparative Examples 10 and 11. Although the mass content (a) of the sodium-supplementing additive was between 5% and 10%, the mass content (b) of the sodium salt additive was between 1% and 10%, and the particle size (c) of the negative electrode active material was between 2 μm and 12 μm, the values of a, b, and c did not satisfy the relationship 0.33a/(b+c)≤1.5. As a result, the batteries exhibited low initial coulombic efficiency, poor cycle performance, high internal resistance, and high DCIR after capacity grading. The results indicate that the parameters a, b, and c are required to satisfy 5≤a≤10, 1≤b≤10, and 2≤c≤12, and also meet the relationship 0.3≤a/(b+c)≤1.5, so as to achieve optimal electrical conductivity of the positive electrode while effectively improving the electrical conductivity of the electrolyte, the diffusion and transport rate of ions in the negative electrode material, thereby reducing the overall internal resistance of the battery and enhancing its initial coulombic efficiency and cycle performance.

According to the comparisons among Embodiments 1-4, when the total mass of the positive electrode active material and the sodium-supplementing additive is 100%, and the mass content (a) of the sodium-supplementing additive is in the range of 5.5%-9%, the batteries exhibit high initial coulombic efficiency, high capacity retention during cycle at both room temperature and high temperature, and low internal resistance. According to the comparisons among Embodiments 5-9, when the mass content (b) of the sodium salt additive in the electrolyte is between 2% and 6%, the electrolyte exhibits relatively high electrical conductivity, while the batteries show low internal resistance and high capacity retention during cycle. According to the comparisons among Embodiments 10-13, when the particle size (c) of the negative electrode active material is in the range of 3-9 μm, the batteries exhibit high initial coulombic efficiency, low DCIR, high capacity retention during cycle, low gas generation, and low internal resistance. According to the comparisons among Embodiments 1-17, when the parameters a, b, and c satisfy 5≤a≤10, 1≤b≤10, 2≤c≤12, and further satisfy 0.5≤a/(b+c)≤1.2, the batteries exhibit high initial coulombic efficiency and excellent cycle performance with low internal resistance.

Embodiment 1 was compared with Embodiment 17. The electrolyte in Embodiment 17 did not contain the additive 1,3-propane sultone. The battery exhibited low capacity retention during cycle, excessive gas generation, and low initial coulombic efficiency. These results indicate that adding 1,3-propane sultone (PS) into the electrolyte can effectively suppress side reactions and the dissolution and deposition of metal ions on the surface of the positive electrode, stabilize the crystal structure of the positive electrode, and effectively reduce the internal resistance and gas generation amount of the battery, thereby improving its cycle performance.

TABLE 3
Performance results of the batteries in Embodiment 1 and Embodiments 18-21

| | | | | | | Gas | |
|---|---|---|---|---|---|---|---|
| | | | | | | Generation | |
| | Electrical | | DCIR | Capacity | Capacity | Amount | Internal |
| | Conductivity | Initial | after | Retention | Retention | after 400 | Resistance |
| | of | Coulombic | Capacity | after 400 | after 400 | Cycles at | of the |
| | Electrolyte | Efficiency | Grading | Cycles at | Cycles at | 45° C. | Battery |
| Group | (mS/cm) | (%) | (mΩ) | 25° C. (%) | 45° C. (%) | (mL) | (mΩ) |
| Embodiment | 7.78 | 90.4 | 44.4 | 94.2 | 92.3 | 14 | 16.6 |
| 1 | | | | | | | |
| Embodiment | 7.78 | 89.1 | 48.8 | 93 | 91.1 | 15.4 | 17.2 |
| 18 | | | | | | | |
| Embodiment | 7.78 | 89.3 | 49.1 | 92.9 | 91 | 15.6 | 17.3 |
| 19 | | | | | | | |
| Embodiment | 7.78 | 89 | 49.2 | 92.7 | 90.7 | 16.1 | 17.2 |
| 20 | | | | | | | |
| Embodiment | 7.78 | 89.2 | 49 | 92.8 | 90.9 | 15.8 | 17.6 |
| 21 | | | | | | | |

According to Tables 1 and 3, Embodiment 1 was compared with Embodiments 18-21.

The batteries containing different types of sodium-supplementing additives exhibited nearly identical initial coulombic efficiency, internal resistance, DCIR, capacity retention during cycle, and gas generation amount. These results indicate that, provided that the sodium-supplementing additive satisfies the compound represented by the Formula 1 NaₓM_{y}O_{z}, where 0.2<x/y<9, 0<y<6, 2≤z≤9, and M is one or more selected from Nb, V, Ta, Mn, Fe, Cr, Co, Ni, Cu, Zn, Mg, Ti, Si, Sn, Ce, and Zr, the additive can improve the initial coulombic efficiency and cycle performance of the battery and reduce its internal resistance.

TABLE 4
Performance results of the batteries in Embodiment 1 and Embodiments 22-23

| | | | | | | Gas | |
|---|---|---|---|---|---|---|---|
| | | | | | | Generation | |
| | Electrical | | DCIR | Capacity | Capacity | Amount | Internal |
| | Conductivity | Initial | after | Retention | Retention | after 400 | Resistance |
| | of | Coulombic | Capacity | after 400 | after 400 | Cycles at | of the |
| | Electrolyte | Efficiency | Grading | Cycles at | Cycles at | 45° C. | Battery |
| Group | (mS/cm) | (%) | (mΩ) | 25° C. (%) | 45° C. (%) | (mL) | (mΩ) |
| Embodiment | 7.78 | 90.4 | 44.4 | 94.2 | 92.3 | 14 | 16.6 |
| 1 | | | | | | | |
| Embodiment | 7.78 | 89.6 | 47.2 | 93.2 | 92.1 | 16.2 | 17.8 |
| 22 | | | | | | | |
| Embodiment | 7.78 | 89.5 | 46.8 | 93 | 92.2 | 15.9 | 17.7 |
| 23 | | | | | | | |

According to Tables 1 and 4, Embodiment 1 was compared with Embodiments 22-23. The batteries containing different types of sodium salt additives exhibited nearly identical initial coulombic efficiency, internal resistance, DCIR, capacity retention during cycle, and gas generation amount. These results indicate that the different types of sodium salt additives provided in the present disclosure can all improve the initial coulombic efficiency and cycle performance of the battery and reduce its internal resistance.

TABLE 5
Performance results of the batteries in Embodiment 1 and Embodiments 24-30

| | | | | | | Gas | |
|---|---|---|---|---|---|---|---|
| | | | | | | Generation | |
| | Electrical | | DCIR | Capacity | Capacity | Amount | Internal |
| | Conductivity | Initial | after | Retention | Retention | after 400 | Resistance |
| | of | Coulombic | Capacity | after 400 | after 400 | Cycles at | of the |
| | Electrolyte | Efficiency | Grading | Cycles at | Cycles at | 45° C. | Battery |
| Group | (mS/cm) | (%) | (mΩ) | 25° C. (%) | 45° C. (%) | (mL) | (mΩ) |
| Embodiment | 7.78 | 90.4 | 44.4 | 94.2 | 92.3 | 14.0 | 16.6 |
| 1 | | | | | | | |
| Embodiment | 7.78 | 90.4 | 44.4 | 94.2 | 92.3 | 16.0 | 16.6 |
| 24 | | | | | | | |
| Embodiment | 7.81 | 89.1 | 47.3 | 93.2 | 91.3 | 15.8 | 16.2 |
| 25 | | | | | | | |
| Embodiment | 7.83 | 89.0 | 48.9 | 93.0 | 91.9 | 13.1 | 15.3 |
| 26 | | | | | | | |
| Embodiment | 7.70 | 79.6 | 94.3 | 73.2 | 71.0 | 52.0 | 35.6 |
| 27 | | | | | | | |
| Embodiment | 7.84 | 78.2 | 99.8 | 65.2 | 62.5 | 36.0 | 38.5 |
| 28 | | | | | | | |
| Embodiment | 7.79 | 91.2 | 43.2 | 95.2 | 93.1 | 14.6 | 16.2 |
| 29 | | | | | | | |
| Embodiment | 7.80 | 90.9 | 42.1 | 95.6 | 93.4 | 13.8 | 16.0 |
| 30 | | | | | | | |

According to Tables 1 and 5, Embodiment 1 was compared with Embodiments 24-28. The electrolytes contained 1,3-propane sultone, and in Embodiments 27 and 28, the mass content of 1,3-propane sultone was not within the range of 0.5%-2%. The batteries exhibited high DCIR, high internal resistance, excessive gas generation amount, and low capacity retention during cycle. These results indicate that when the mass content of 1,3-propane sultone (PS) in the electrolyte is within the range of 0.5%-2%, side reactions and the dissolution and deposition of metal ions on the surface of the positive electrode can be effectively suppressed, the crystal structure of the positive electrode can be stabilized, and the internal resistance and gas generation amount of the battery can be effectively reduced, thereby improving the cycle performance. When the content of PS in the electrolyte is within the range of 1%-2%, the batteries exhibit lower internal resistance and lower gas generation amount.

Embodiment 1 was compared with Embodiments 29-30. In Embodiments 29 and 30, both 1,3-propane sultone and an auxiliary additive were added into the electrolyte. The batteries exhibited reduced DCIR and internal resistance, and the gas generation amount during cycle was significantly reduced, while the initial coulombic efficiency increased and the capacity retention during cycle improved. These results indicate that the addition of 1,3-propane sultone into the electrolyte, in cooperation with the auxiliary additive, reduces the DCIR, internal resistance, and gas generation amount of the battery, and improves its initial coulombic efficiency and cycle performance.

The above are only preferred embodiments of the present disclosure and are not intended to limit the scope of the disclosure. Any modifications, equivalent substitutions, or improvements made within the spirit and principle of the present disclosure should be included within the scope of protection of the application.

What is claimed is:

1. A sodium-ion battery, comprising: a non-aqueous electrolyte, a positive electrode, and a negative electrode, wherein the non-aqueous electrolyte comprises an additive, the additive comprising a sodium salt additive, the positive electrode comprises a positive electrode active substance layer, the positive electrode active substance layer comprising a sodium-supplementing additive and a positive electrode material, the sodium-supplementing additive being a sodium-rich transition metal oxide, the negative electrode comprises a negative electrode active material;
the sodium-ion battery satisfies the following relationship:
$$0.3 \leq a / ( b + c ) \leq 1.5 , and 5 \leq a \leq 10 , 1 \leq b \leq 10 , 2 \leq c \leq 12 ;$$
wherein:
a total mass of the sodium-supplementing additive and the positive electrode active material is 100%, a represents a mass content of the sodium-supplementing additive, in %;
b represents a mass content of the sodium salt additive in the non-aqueous electrolyte, in %; and
c represents a particle size of the negative electrode active material, in μm.

2. The sodium-ion battery of claim 1, wherein the sodium-ion battery satisfies the following relationship: 0.5≤a/(b+c)≤1.2.

3. The sodium-ion battery of claim 1, wherein the total mass of the sodium-supplementing additive and the positive electrode active material is 100%, and the mass content (a) of the sodium-supplementing additive is in a range of 5.5%-9%.

4. The sodium-ion battery of claim 1, wherein the sodium salt additive comprises one or more selected from the group consisting of sodium bis(fluorosulfonyl)imide, sodium difluoro (oxalato) borate, and sodium difluorophosphate.

5. The sodium-ion battery of claim 1, wherein the mass content (b) of the sodium salt additive in the non-aqueous electrolyte is in a range of 2%-6%.

6. The sodium-ion battery of claim 1, wherein the particle size (c) of the negative electrode active material is in a range of 3 μm-9 μm.

7. The sodium-ion battery of claim 1, wherein the additive further comprises 1,3-propane sultone, and a mass content of the 1,3-propane sultone in the non-aqueous electrolyte is 0.5%-2%.

8. The sodium-ion battery of claim 7, wherein the mass content of the 1,3-propane sultone in the non-aqueous electrolyte is 1%-2%.

9. The sodium-ion battery of claim 1, wherein the sodium-rich transition metal oxide comprises a compound represented by Formula 1: 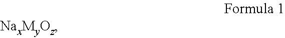
where 0.2<x/y<9, 0<y<6, and 2≤z≤9, and M is selected from one or more of Nb, V, Ta, Mn, Fe, Cr, Co, Ni, Cu, Zn, Mg, Ti, Si, Sn, Ce, and Zr.

10. The sodium-ion battery of claim 9, wherein the sodium-rich transition metal oxide comprises one or more selected from the group consisting of Na₅NbO₅, Na₃NbO₄, Na₄Nb₂O₇, Na₅VO₅, Na₃VO₄, and Na₃TaO₄.

11. The sodium-ion battery of claim 1, wherein the non-aqueous electrolyte further comprises an electrolyte salt, an auxiliary additive, and a non-aqueous organic solvent;
the electrolyte salt comprising at least one selected from the group consisting of sodium hexafluorophosphate, sodium trifluoromethanesulfonimide, sodium trifluoromethanesulfonate, sodium tetrafluoroborate, sodium perchlorate, sodium hexafluoroarsenate, sodium trifluoroacetate, sodium tetraphenylborate, and sodium bis(trifluoromethanesulfonyl)imide;
a mass content of the electrolyte salt, based on a total mass of the electrolyte being 100%, is 8%-14%;
the auxiliary additive comprising at least one selected from the group consisting of 1,4-butane sultone, 1,3-propylene sultone, ethylene sulfate, and fluoroethylene carbonate;
a mass content of the auxiliary additive, based on the total mass of the electrolyte being 100%, is 2.5%-10%; and
the non-aqueous organic solvent comprising at least one selected from the group consisting of carbonate esters having 3-5 carbon atoms, carboxylic esters having 2-6 carbon atoms, and ethers having 4-10 carbon atoms.

12. The sodium-ion battery of claim 1, wherein the positive electrode active material comprises at least one selected from the group consisting of layered transition metal oxides, Prussian-type compounds, phosphate-type compounds, and sulfate-type compounds;
the negative electrode active substance layer comprises a negative electrode active substance, the negative electrode active substance comprising one or more selected from the group consisting of carbon-based materials, silicon-based materials, and tin-based materials.
